(19) United States
(12) Patent Application Publication
(10) Pub. No.: US 2015/0270783 A1
(43) Pub. Date: Sep. 24, 2015

(54) DC-DC CONVERTER, I/O MODULE INCLUDING THE SAME, AND METHOD FOR CONTROLLING DC-DC CONVERTER

(71) Applicants: Haoran Li, Hangzhou (CN); Huan Shi, Hangzhou (CN); Axel Lohbeck, Hangzhou (CN)

(72) Inventors: Haoran Li, Hangzhou (CN); Huan Shi, Hangzhou (CN); Axel Lohbeck, Hangzhou (CN)

(73) Assignee: ABB Technology Ltd., Zurich (CH)

(21) Appl. No.: 14/440,965

(22) PCT Filed: Nov. 8, 2012
(86) PCT No.: PCT/CN2012/084340

§ 371 Date: May 6, 2015

(51) Int. Cl. H02M 3/335

(52) U.S. Cl. CPC H02M 3/33546

(57) ABSTRACT

Embodiments of the present invention provide a DC-DC converter, an input/output (I/O) module including the DC-DC converter, and a method for controlling DC-DC converter. The converter can comprise a planar transformer (2); a first switch element (3) connected between one end of primary winding of the planar transformer and a ground potential, and a second switch element (4) connected between the other end of the primary winding of the planar transformer and a ground potential. The first and second switch elements (3; 4) are respectively controlled to be closed alternately.

### FIELD OF INVENTION

Embodiments of the present invention relate to the field of DC-DC conversion, and especially a DC-DC converter, an input/output (I/O) module including the DC-DC converter, and a method for controlling DC-DC converter.

### BACKGROUND ART

Discrete Controlling System (DCS) and field instruments are widely used as main components of industrial automation. Taking safety and power efficiency into consideration, a 24V DC supply voltage is now becoming a main choice as a supply voltage of I/O modules of the DCS and field instruments. Since the I/O module of the DCS and field instrument is mainly used for processing a field signal and receiving/sending data from a controller via a communication interface, the I/O module itself can be divided into two major parts, for example, a system part and a field part. The system part normally contains functions such as Micro Control Unit (MCU) support, firmware storage and execution, and the field part is normally designed for field signal sampling/output. Usually, the supply voltage of the system part and the field part are different from each other. Because of the requirement of different supply voltages, the 24V DC supply voltage needs to be converted to desired supply voltages.

The prior art solution for DC-DC conversion in the I/O module uses a standard DC-DC transformer. However, the standard DC-DC transformer is expensive. Another disadvantage of the standard DC-DC transformer is that its output voltage is fixed and not flexible while some other components also need different supply voltages.

### SUMMARY OF INVENTION

Hence, in order to overcome one or more of the deficiencies in the prior art mentioned above, at least one of objectives of embodiments of the present invention is to provide a DC-DC converter.

Another objective of embodiments of the present invention is to provide an input/output (I/O) module including a DC-DC converter.

A further objective of embodiments of the present invention is to provide a method for controlling a DC-DC converter.

According to one aspect of the embodiments of the present invention, there is provided a DC-DC converter. The DC-DC converter can comprise: a planar transformer; a first switch element connected between one end of the primary winding of the planar transformer and a ground potential, and a second switch element connected between the other end of the primary winding of the planar transformer and a ground potential. The first and second switch elements are respectively controlled to be closed alternately.

According to an exemplary embodiment, the planar transformer has a first tap provided at a primary winding thereof. The first tap is connected to a DC power supply.

According to an exemplary embodiment, the converter can further comprise a switch driving circuit for generating signals for controlling closing and opening of the first and second switch elements.

According to an exemplary embodiment, the driving circuit can comprise a first logic circuit having a first input for receiving a reference frequency signal, a second input for receiving a first divided frequency signal, and an output for outputting a signal controlling closing and opening of the first switch element. The driving circuit can further comprise a second logic circuit having a first input for receiving the reference frequency signal, a second input for receiving a second divided frequency signal, and an output for outputting a signal controlling closing and opening of the second switch element. In the embodiment, the first divided frequency signal and the second divided frequency signal have opposite phases, and have a fractional frequency of the reference frequency signal.

According to an exemplary embodiment, the first divided frequency signal and the second divided frequency signal have a half frequency of the reference frequency signal.

According to an exemplary embodiment, the converter can further comprise an oscillator for generating the reference frequency signal, and the first divided frequency signal and the second divided frequency signal. The oscillator may be a multivibrator, which may generate a square wave with a certain frequency.

According to an exemplary embodiment, the oscillator can comprise a RC circuit comprising a resistance and a capacitor.

According to an exemplary embodiment, the first and second logical circuits are AND logic circuits. The signal controlling the first switch element is generated by a AND operation between the reference frequency signal and the first divided frequency signal. The signal controlling the second switch element is generated by a AND operation between the reference frequency signal and the second divided frequency signal. In this embodiment, the overlap of the high level of the two controlling signals are avoid, such that the two switch element can be closed alternately without the occurrence of simultaneous close of the two switch elements.

According to an exemplary embodiment, the first and second logical circuits are NOR logical circuits. The signal controlling the first switch element is generated by a NOR operation between the reference frequency signal and the first divided frequency signal. The signal controlling the second switch element is generated by a NOR operation between the reference frequency signal and the second divided frequency signal. In this embodiment, the overlap of the high level of the two controlling signals are avoid, such that the two switch element can be closed alternately without the occurrence of simultaneous close of the two switch elements.

According to an exemplary embodiment, the first and second switch elements may be any kind of common electrical element with switching function, such as MOSFET, IGBT or thyristors.

According to an exemplary embodiment, a second tap is provided at a secondary winding of the planar transformer such that an output voltage of the planar transformer is adjustable by moving the second tap.

According to an exemplary embodiment, the converter can further comprise a rectifying circuit at a secondary winding side of the planar transformer.

According to an exemplary embodiment, the converter can further comprise a filtering capacitor at a secondary winding side of the planar transformer.

According to an exemplary embodiment, the converter is integrated in a PCB board. Thus, the size of the converter can be minimized, and the converter can be readily used in a limited space.

According to another aspect of the embodiments of the present invention, there is provided a device comprising a DC-DC converter described above.

According to an exemplary embodiment, the device can be an I/O module or instrument.

According to a further aspect of the embodiments of the present invention, there is provided a method for controlling a DC-DC converter. The DC-DC converter can comprise a planar transformer having a first tap provided at a primary winding thereof and connected to a DC power supply, a first switch element between one end of primary winding of the planar transformer and a ground potential, and a second switch element between the other end of the primary winding of the planar transformer and a ground potential. The method can comprise respectively controlling the first and second switch elements to be closed alternately.

According to an exemplary embodiment, the method can further comprises: generating a signal controlling closing and opening of the first switch element by performing a first logic operation between a reference frequency signal and a first divided frequency signal, and generating a signal controlling closing and opening of the second switch element by performing a second logic operation between the reference frequency signal and a second divided frequency signal. In the exemplary embodiment, the first divided frequency signal and the second divided frequency signal have opposite phases, and have a fractional frequency of the reference frequency signal.

According to an exemplary embodiment, the first divided frequency signal and the second divided frequency signal have a half frequency of the reference frequency signal.

According to an exemplary embodiment, both the first and second logical operations are AND logic operations.

According to an exemplary embodiment, both the first and second logical operations are NOR logic operations.

According to an exemplary embodiment, the DC-DC converter can further comprise a second tap provided at a secondary winding of the planar transformer. The method can further comprise adjusting an output voltage of the planar transformer by moving the second tap.

According to an exemplary embodiment, the first and second switch elements are selected from MOSFETs, IGBTs or thyristors.

In accordance with the embodiments of the present invention, the planar transformer is used in the DC-DC converter, and the solution is not only good for reducing product size and cost, but also good for reducing module complexity and save PCB layout time.

Further, In accordance with the embodiments of the present invention, the overlap of the high level of the two controlling signals is avoid, such that the two switch elements can be closed alternately without the occurrence of simultaneous close of the two switch elements.

Furthermore, benefited by its small size and simple structure, the DC-DC conversion component can be readily distributed to I/O itself, such that risk of extra power supply is eliminated.

### BRIEF DESCRIPTION OF THE DRAWINGS

When reading the following detailed description on the exemplary embodiments with reference to the drawings, the aim, features and advantages of the present invention become obvious, wherein

FIG. 1 illustrates the schematic circuit diagram of DC-DC converter in an exemplary embodiment of the present invention.

FIG. 2 illustrates the driving signals for planar transformer according to the embodiment of FIG. 1.

FIG. 3 illustrates the schematic circuit diagram of DC-DC converter in another exemplary embodiment of the present invention. and

FIG. 4 illustrates the driving signals for planar transformer according to the embodiment of FIG. 3.

### DETAILED DESCRIPTION OF EMBODIMENTS

Hereinafter, exemplary embodiments will be referred to in describing the mechanism and spirit of the present invention. It should be understood that these embodiments are merely provided to facilitate those skilled in the art in understanding and in turn implementing the present invention, but not for limiting the scope of the present invention in any way.

Various embodiments of the present invention are described in detail herein in an exemplary way by referring to the drawings.

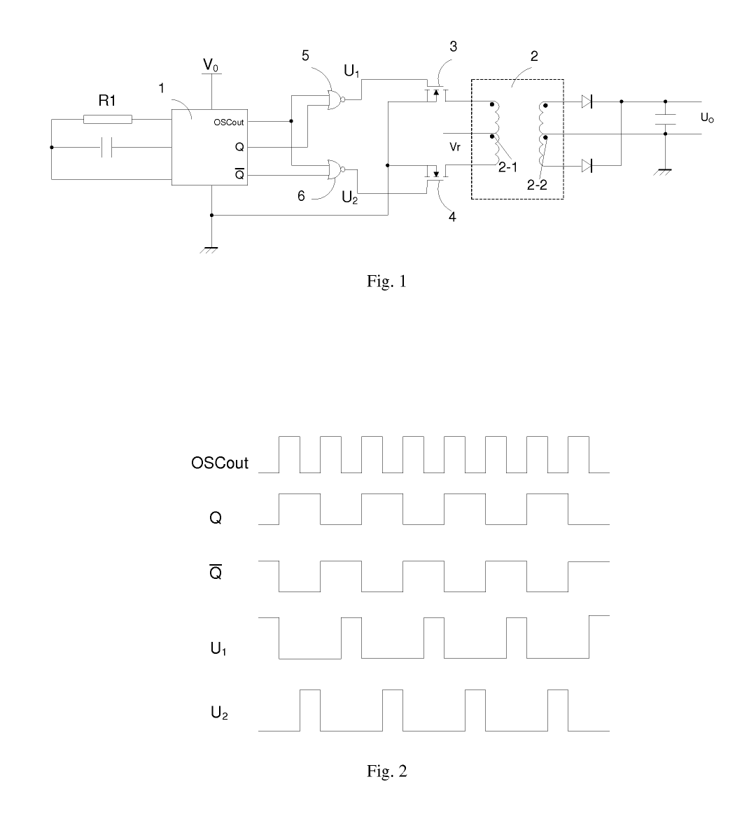

FIG. 1 illustrates the schematic circuit diagram of the DC-DC converter according to an exemplary embodiment of the present invention.

As shown in FIG. 1, the DC-DC converter according to the embodiment of the present invention can comprise a planar transformer 2. The use of the planar transformer is quite easy for I/O module since the current and power consumption is relatively small for I/O itself. In this embodiment, a tap 2-1 can be provided on the primary winding of the planar transformer 2. For example, the tap 2-1 can divide the length of the primary winding into two parts with equal length, i.e. an upper half and a lower half. The purpose of doing this will be described later. In this embodiment, the tap 2-1 is connected to the positive pole of the DC power supply which serves as the input of the planar transformer 2 and provides the input DC voltage Vr.

As further shown in FIG. 1, in the exemplary embodiment, one end of the primary winding of the planar transformer 2 can be connected to a first switch element 3, and the other end of the primary winding of the planar transformer 2 can be connected to a second switch element 4. Furthermore, both the first and second switch elements are further connected to ground. Namely, in this exemplary embodiment, the first switch element 3 is connected between one end of the primary winding of the planar transformer 2 and a ground potential, and the second switch element 4 is connected between the other end of the primary winding of the planar transformer 2 and the ground potential. Thus, two parallel circuits are formed between the DC input of the tap 2-1 and the ground potential with each branch having a switch element and half of a primary winding. The ground potential herein is a zero potential such as a cathode of the DC input voltage supply or ground. It can be implemented by connecting the terminal of the switches to any position with zero potential, such as ground or a cathode terminal of the DC input voltage supply.

As further shown in FIG. 1, in the exemplary embodiment, each of the first and second switch elements 3, 4 has a controlling terminal respectively. The controlling terminal can be connected to a switch driving circuit for generating signals for controlling alternate closing and opening of the first and second switch elements 3, 4, which will be described below. In the embodiment of the present invention, the switch elements may be any kind of common electrical element with switching function, such as MOSFET, IGBT or thyristors.

According to the embodiment of the present invention, under the controlling of the frequency signals, the first and second switch elements 3, 4 are closed alternately, thus the current from the DC power supply passes through the upper and lower half primary winding of the planar transformer alternately. The alternate changing of the current generates the changing magnetic field, which in turn induces an induced potential in the secondary winding of the planar transformer. The alternate working manner of the two branches is called push-pull manner, and the switch driving circuit in combination with the transformer is called push-pull circuit. This kind of circuit is used herein because it is suitable for medium or small power for low voltage which is the case in switch mode power supply, such as DC-DC conversion in I/O module. In this embodiment, the equal length of the upper and lower halves of the primary winding divided by the tap 2-1 is to avoid the magnetic bias in the primary winding. However, the present invention is not limited to this.

The induced potential generated in the secondary winding of the planar transformer is a square wave. After rectified by a rectifying circuit including diodes and a capacitor, the output voltage Uo of the planar transformer would be DC voltage.

In order to control the first and second switch elements 3, 4 to be closed alternately, the two sequences of frequency signals applied to the switch elements contain high levels in the time line alternately. When a high level is applied on the first switch element 3, the first switch element 3 is closed, while a low level is applied on the second switch element 4, and the second switch element 4 thus keeps open, and vice versa.

In the exemplary embodiment, the DC-DC converter further comprises an oscillator 1 for generating the frequency signals. Preferably, the oscillator 1 is a multivibrator. As shown in FIG. 1, a voltage V₀ is provided to the oscillator 1 to power the oscillator 1. The output frequency of the oscillator 1 usually may be adjusted by a RC circuit comprising a resistance and a capacitor. The two controlling signal with alternate high level may be generated by an oscillator or in the aid of some peripheral circuit. As an example shown in FIG. 1, the OSCout pin of the multivibrator 1 outputs a reference frequency signal, the frequency of which is determined by the value of the resistance and capacitor in the RC circuit. The Q pin of the oscillator 1 outputs a first divided frequency signal with a fractional frequency of the reference frequency, and the Q̅ pin of the multivibrator 1 outputs a second divided frequency signal with the a fractional frequency of the reference frequency signal and opposite phase relative to the first divided frequency signal. In an exemplary embodiment, the first divided frequency signal (Q) and the second divided frequency signal ( Q̅) have a half frequency of the reference frequency signal. It should be understood that other fractional frequency is also applicable. The signals from the OSCout, Q and Q̅ pins are illustrated in FIG. 2.

Preferably, the signals from Q and Q̅ pins are not used for controlling the first and second switch elements directly since the delay of the jump between the high and low level of the two signals due to the nature of electronic apparatus may cause a overlap of the high levels in the signals from Q and Q̅ pins in some short period, which would make the two switch elements 3, 4 to be close simultaneously. If so, the current from the power source Vr would pass through the upper half and lower half of the primary winding simultaneously with opposite direction, and thus the opposite induced magnetic field would be generated in the upper half and lower half of the primary winding, and thus the total induced magnetic field in the whole winding would be zero and the load on the winding would be considered as zero, which would in turn cause a short circuit such that the transformer and other elements in the driving circuit would be damaged.

To avoid the risk of the overlap of the high levels in the signals from Q and Q̅ pins in some short period, in some embodiments of the present invention, the DC-DC converter can further comprise a switch driving circuit for generating signals for controlling alternate closing and opening of the first and second switch elements 3, 4. The controlling terminals of both the first and second switch elements 3, 4 are connected to the oscillator 1 via the switch driving circuit.

In this embodiment of FIG. 1, the switch driving circuit can comprise a first logic circuit 5 having a first input for receiving a reference frequency signal OSCout, a second input for receiving the first divided frequency signal Q, and an output for outputting a signal U1 controlling closing and opening of the first switch element 3. The switch driving circuit further comprises a second logic circuit 6 having a first input for receiving the reference frequency signal OSCout, a second input for receiving a second divided frequency signal Q̅, and an output for outputting a signal U2 controlling closing and opening of the second switch element 4. The first divided frequency signal Q and the second divided frequency signal Q̅ have opposite phases, and have a fractional frequency of the reference frequency signal.

In the embodiment shown in FIG. 1, the first and second logic circuits 5, 6 are two NOR logic circuits respectively. The signal U1 controlling the first switch element 3 is generated by a NOR operation between the reference frequency signal OSCout and the first divided frequency signal Q, and the signal U2 controlling the second switch element 4 is generated by a NOR operation between the reference frequency signal OSCout and the second divided frequency signal Q̅. It can be seen from the FIG. 2 that after NOR operation, there are short time interval between the falling edge of the signal U1 and the rising edge of the signal U2, and also between the falling edge of the signal U2 and the rising edge of the signal U1. Therefore there is no risk of overlap of the high level between the signal U1 and U2 even if the signal delay caused by the physical nature of the electronic elements is taken into account, and thus the simultaneous close of the two switch elements is avoided.

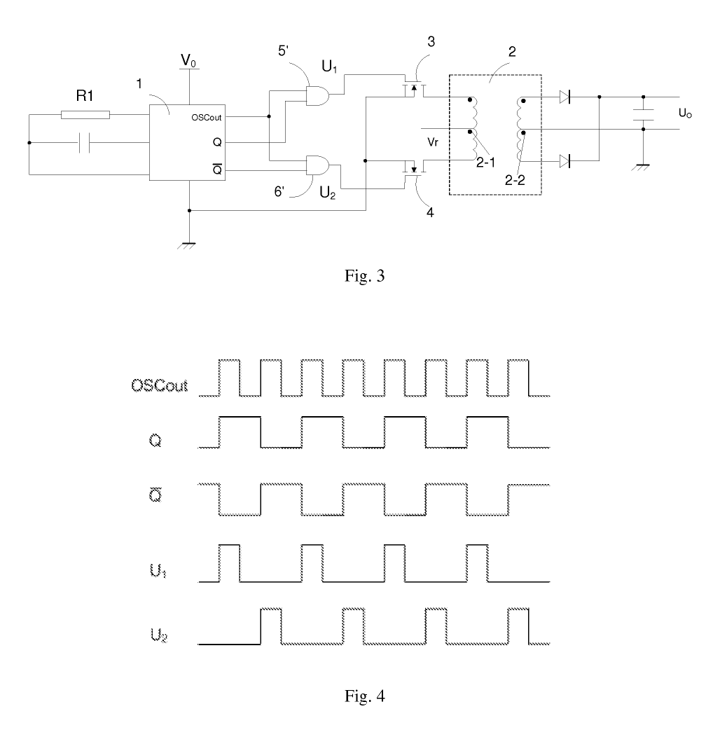

FIG. 3 illustrates the schematic circuit diagram of DC-DC converter in another exemplary embodiment of the present invention.

The circuit diagram in FIG. 3 is similar to the circuit diagram in FIG. 1, and the same reference number indicates the same feature. The main difference between the DC-DC converters of FIG. 1 and FIG. 3 is in that the logical circuits 5, 6 in FIG. 1 are replaced with AND logical circuits in FIG. 3.

As shown in FIG. 3, the first and second logic circuits are 5, 6 are two AND logic circuits respectively. The signal U1 controlling the first switch element 3 is generated by a AND operation between the reference frequency signal OSCout and the first divided frequency signal Q, and the signal U2 controlling the second switch element 4 is generated by a AND operation between the reference frequency signal OSCout and the second divided frequency signal Q̅. It can be seen from the FIG. 4 that after AND operation, there are also short time interval between the falling edge of the signal U1 and the rising edge of the signal U2, and also between the falling edge of the signal U2 and the rising edge of the signal U1. The output signal U1/U2 from AND operation differs from that from NOR operation only in the initial phase, while the frequency and the phase difference between signal U1 and U2 are the same. Therefore there is also no risk of overlap of the high level between the signal U1 and U2, and the advantage of the NOR logical circuit can also be obtained by the AND logical circuit.

It is appreciated that the NOR logic circuit shown in FIG. 1 and the AND logical circuit shown in FIG. 3 is schematic only, and other logic circuit may also be applicable as long as overlap of the high level between the signal U1 and U2 can be avoid.

Return to FIG. 1, preferably, there is a tap 2-2 in the secondary winding of the planar transformer 2, such that the output DC voltage Uo of the planar transformer may be adjusted by moving the tap 2-2. Moving the tap 2-2 would change the length of the secondary winding connected in the secondary side circuit, and thus would change the ratio of the winding length of the primary and secondary side which would determine the output voltage of the transformer. It should be appreciated that there are also some other known methods to change the output voltage of the transformer, such as changing the frequency of the driving signal to the switch elements 3, 4.

Due to the simple structure and small size of the DC-DC converter of the embodiments of the present invention, the DC-DC converter may be integrated in a PCB board. The converter may be readily integrated in I/O module and instruments as a functional module. Thus, a special power supply/conversion module can be replaced, which means the low cost for DC-DC conversion is obtained, while the risk on the reliability is minimized. Moreover, compared with normal fixed output voltage transformer, output voltage of planar transformer of the embodiments of the present invention can be easily adjusted, so that the flexibility of the converter makes the application of it extended.

The embodiment of the present invention also provides a method for controlling a DC-DC converter. The DC-DC converter is configured to comprise a planar transformer having a first tap provided at a primary winding thereof and connected to a DC power supply, a first switch element between one end of primary winding of the planar transformer and a ground potential, and a second switch element between the other end of the primary winding of the planar transformer and a ground potential. The method can comprise respectively controlling the first and second switch elements to be closed alternately.

In an exemplary embodiment, the method can further comprise: generating a signal controlling closing and opening of the first switch element by performing a first logic operation between a reference frequency signal and a first divided frequency signal, and generating a signal controlling closing and opening of the second switch element by performing a second logic operation between the reference frequency signal and a second divided frequency signal. In an exemplary embodiment, the first divided frequency signal and the second divided frequency signal have opposite phases, and have a fractional frequency of the reference frequency signal.

In an exemplary embodiment, the first divided frequency signal and the second divided frequency signal have a half frequency of the reference frequency signal.

Further, in an exemplary embodiment, both the first and second logical operations are NOR logic operations as shown in FIG. 1. Furthermore, in an exemplary embodiment, both the first and second logical operations are AND logic operations as shown in FIG. 3.

In an exemplary embodiment, the DC-DC converter can further comprise a second tap provided at a secondary winding of the planar transformer. The method can further comprise adjusting an output voltage of the planar transformer by moving the second tap.

By studying the drawings, the disclosure of the embodiments of the present invention, and the attached Claims, those skilled in the art may understand and implement other modifications of the disclosed embodiments during the implementation of the present invention. In the claims, “comprising” does not exclude other elements or steps, and “a” or “one” does not exclude the plural concept. The simple fact of illustrating specific elements in the dependent claims, which are mutually different from each other, does not indicate that the combination of these elements cannot be used advantageously. The labels in drawings of the claims should not be interpreted as limiting the scopes thereof.

Though the present invention has been described with reference to the currently considered embodiments, it should be appreciated that the present invention is not limited the disclosed embodiments. On the contrary, the present invention is intended to cover various modifications and equivalent arrangements falling within in the spirit and scope of the appended claims. The scope of the appended claims is accorded with broadest explanations and covers all such modifications and equivalent structures and functions.

1. A DC-DC converter, comprising:
a planar transformer;
a first switch element connected between one end of primary winding of the planar transformer and a ground potential, and
a second switch element connected between the other end of the primary winding of the planar transformer and a ground potential;
wherein the first and second switch elements are respectively controlled to be closed alternately.

2. The converter according to claim 1, wherein the planar transformer has a first tap provided at a primary winding thereof, which is connected to a DC power supply.

3. The converter according to claim 1, further comprising: a switch driving circuit for generating signals for controlling closing and opening of the first and second switch elements.

4. The converter according to claim 3, wherein the switch driving circuit comprises:
a first logic circuit having a first input for receiving a reference frequency signal (OSCout), a second input for receiving a first divided frequency signal (Q), and an output for outputting a signal (U1) controlling closing and opening of the first switch element, and
a second logic circuit having a first input for receiving the reference frequency signal (OSCout), a second input for receiving a second divided frequency signal ( Q̅), and an output for outputting a signal (U2) controlling closing and opening of the second switch element,
wherein the first divided frequency signal (Q) and the second divided frequency signal ( Q̅) have opposite phases, and have a fractional frequency of the reference frequency signal.

5. The converter according to claim 4, wherein the first divided frequency signal (Q) and the second divided frequency signal ( Q̅) have a half frequency of the reference frequency signal.

6. The converter according to claim 4, further comprising:
an oscillator for generating the reference frequency signal (OSCout), and the first divided frequency signal (Q) and the second divided frequency signal ( Q̅).

7. The converter according to claim 4, wherein the first and second logical circuits are AND logic circuits,
the signal (U1) controlling the first switch element is generated by an AND operation between the reference frequency signal (OSCout) and the first divided frequency signal (Q), and
the signal (U2) controlling the second switch element is generated by an AND operation between the reference frequency signal (OSCout) and the second divided frequency signal ( Q̅).

8. The converter according to claim 4, wherein the first and second logical circuits are NOR logical circuits,
the signal (U1) controlling the first switch element generated by a NOR operation between the reference frequency signal (OSCout) and the first divided frequency signal (Q), and
the signal (U2) controlling the second switch element is generated by a NOR operation between the reference frequency signal (OSCout) and the second divided frequency signal ( Q̅).

9. The converter according to claim 1, wherein the first and second switch elements are selected from MOSFETs, IGBTs or thyristors.

10. The converter according to claim 1, wherein a second tap is provided at a secondary winding of the planar transformer such that an output voltage of the planar transformer is adjustable by moving the second tap.

11. The converter according to claim 1, further comprising: a rectifying circuit at a secondary winding side of the planar transformer.

12. The converter according to claim 1, wherein the converter is integrated in a PCB board.

13. A device comprising a DC-DC converter according to claim 1.

14. The device according to claim 13, wherein the device is an I/O module.

15. A method for controlling a DC-DC converter, wherein the DC-DC converter comprises a planar transformer having a first tap provided at a primary winding thereof and connected to a DC power supply, a first switch element between one end of the primary winding of the planar transformer and a ground potential, and a second switch element between the other end of the primary winding of the planar transformer and a ground potential, the method comprising:
respectively controlling the first and second switch elements to be closed alternately.

16. The method according to claim 15, further comprising:
generating a signal (U1) controlling closing and opening of the first switch element by performing a first logic operation between a reference frequency signal (OSCout) and a first divided frequency signal (Q), and
generating a signal (U1) controlling closing and opening of the second switch element by performing a second logic operation between the reference frequency signal (OSCout) and a second divided frequency signal ( Q̅),
wherein the first divided frequency signal (Q) and the second divided frequency signal ( Q̅) have opposite phases, and have a fractional frequency of the reference frequency signal.

17. The method according to claim 16, wherein the first divided frequency signal (Q) and the second divided frequency signal ( Q̅) have a half frequency of the reference frequency signal.

18. The method according to claim 16, wherein both the first and second logical operations are AND logic operations or NOR logical operations.

19. The method according to claim 15, wherein the DC-DC converter further comprises a second tap provided at a secondary winding of the planar transformer, wherein the method further comprises:
adjusting an output voltage of the planar transformer by moving the second tap.

20. The method according to claim 15, wherein the first and second switch elements are selected from MOSFETs, IGBTs or thyristors.
